(19) United States
(12) Patent Application Publication
(10) Pub. No.: US 2014/0202348 A1
(43) Pub. Date: Jul. 24, 2014

(54) MULTILAYERED STRUCTURE FOR USE AS PRINTING BLANKET OR PRINTING PLATE FOR RELIEF PRINTING INCLUDING FLEXOGRAPHIC PRINTING

(71) Applicant: ContiTech Elastomer-Beschichtungen GmbH, Hannover (DE)

(72) Inventors: Stefan Fuellgraf, Duderstadt (DE); Armin Senne, Ettenheim (DE); Torsten Raschdorf, Einbeck (DE); Gabriele Lindenthal, Northeim (DE)

(73) Assignee: ContiTech Elastomer-Beschichtungen GmbH, Hannover (DE)

(21) Appl. No.: 14/220,089

(22) Filed: Mar. 19, 2014

Related U.S. Application Data
(63) Continuation of application No. PCT/EP2012/066305, filed on Aug. 22, 2012.
(60) Provisional application No. 61/536,364, filed on Sep. 19, 2011.

(30) Foreign Application Priority Data
Sep. 19, 2011 (DE) 10 2011 053 748.1

(51) Int. Cl. B41N 10/04

(52) U.S. Cl. CPC B41N 10/04
USPC 101/395; 101/401.1

(57) ABSTRACT

A multilayered structure is for use as one of a printing blanket and a printing plate for relief printing including flexographic printing. The multilayered structure has a first layer including a vulcanizate based on at least one elastomer and at least one further layer adhesively connected to the first layer in such a manner that the first layer is peelable or strippable from the further layer.

### CROSS REFERENCE TO RELATED APPLICATIONS

This application is a continuation application of international patent application PCT/EP2012/066305, filed Aug. 22, 2012 which designates the United States and claims priority from United States Provisional Application No. 61/536,364 filed Sep. 19, 2011, and German patent application 10 2011 053 748.1 filed Sep. 19, 2011. The present continuation application claims priority to each of the above applications and incorporates herein the entire contents thereof by reference.

### FIELD OF THE INVENTION

The invention relates to a multilayer sheet for use as printing blanket or printing plate for relief printing, in particular flexographic printing. The multilayer sheet has a first layer including a vulcanizate based on at least one elastomer, and includes at least one further layer. The invention further relates to a process for the production of a multilayer sheet of this type.

### BACKGROUND OF THE INVENTION

Printing technology is concerned with the reproduction of print originals by transferring printing inks from a printing means to a print substrate such as paper, paperboard, or plastic. This technology includes the process of relief printing, which uses print elements raised above the lower areas on the printing means, that is, the image-forming areas of the printing means are higher than the non-image-forming areas. The printing ink is provided to the elevated print elements or image-forming areas, which thus form the print original which can then be transferred to the print substrate in order to replicate the print original thereon.

The printing means can be a multilayer sheet which can take the form of a printing plate or else of a printing blanket. In both cases, the multilayer sheet includes, as uppermost layer, a printing layer orientated toward the print substrate. The printing layer can be present on a reinforcing layer. If the printing layer and optionally the reinforcing layer is/are flexible, for example, by virtue of photopolymers, the term flexographic printing process is used. Further layers between the printing layer and the optional reinforcing layer are possible in the relief printing process, for example, in the form of a compressible layer. There can also be a plurality of compressible layers and reinforcing layers, preferably arranged in alternation. All of the layers conventionally form an adhesive bond to one another, that is, the layers adjacent to one another have adhesive bonding to one another, that is, have coherent bonding via, for example, adhesives or via vulcanization.

In the relief printing process and in particular in the flexographic printing process, laser engraving can be used to form the elevated print elements or elevated image-forming areas of the print original. To this end, the printing layer includes photopolymers. The term photopolymers means plastics which are hardened by light, for example, epoxy resins. In a possible alternative, the elevated print elements or elevated image-forming areas can also be produced via mechanical operations, for example, via milling on the printing layer.

This type of printing layer made of photopolymer is described by way of example in the U.S. Pat. No. 6,935,236. In this case, the printing layer includes an elastomeric binder, a polymerizable compound, a photoinitiator or a photoinitiator system, and also a fine-particle filler, for example made of a fumed oxide (silicon oxide, titanium oxide, aluminum oxide). Laser light is used here to irradiate the material of the printing layer at the areas which subsequently form the print elements or which subsequently form the image-forming areas, while no laser light irradiates the other regions. The irradiation, for example with actinic light, causes full-area crosslinking (vulcanization) of the printing layer in the regions of the subsequent print elements or subsequent image-forming areas, and as a result of this a printing relief is engraved via a laser into the printing layer. Another term then used for the resultant region of the printing layer, after the laser treatment, is relief layer, print relief, printing means, or print original. No crosslinking of the photopolymers occurs in the unirradiated regions, and after irradiation these can therefore by way of example be extracted by washing, and they form the lower areas or the non-image-forming areas of the printing layer.

Examples of disadvantages here are that the production of a printing means is very complicated because of a plurality of operations. The dynamic stiffness of the material mostly leads to a requirement for adjustment of the pressure applied during the printing process at various speeds. Another feature of the photopolymeric printing layer or photopolymeric print original is low ink transfer values. Defects can also occur during the mounting of the irradiated photopolymeric sheet. Finally, the products cannot always take the form of rolls, and the end user therefore has to have various formats in inventory.

In order to overcome the disadvantages, United States patent application publication 2012/0103216 teaches use of a vulcanizate as the polymeric material of the printing layer, that is, generating complete crosslinking of the polymers through vulcanization of the entire printing layer, in such a way that there is no longer any requirement for laser engraving of the print elements or of the image-forming areas, and subsequent washing for extraction of the unirradiated regions of the lower areas or non-image-forming areas of the printing layer. Instead, the multilayer sheet of United States patent application publication 2012/0103216, provided with a vulcanized printing layer, is supplied in the form of a printing blanket or of a printing plate as rolls to the customer, who mounts the roll product onto a sleeve (adapter, print cylinder). In the regions that are intended to form the lower areas or to form the non-image-forming areas of the printing layer, the printing layer is then ablated, for example, by a laser or by mechanical operations, for example, milling combined with subsequent cleaning, in order thus to form the print original.

In conjunction with laser technologies now available, it is possible to introduce an engraved pattern with points with various depths and shapes within the vulcanizate of a printing layer. The ablation of the vulcanizate of the printing layer to form the lower areas or non-image-forming areas of the print original takes place here in a manner that is rapid, clean, and solvent-free. 100% register accuracy and reproducibility is ensured here. A fact of major economic significance is that in accordance with the teaching of United States patent application publication 2012/0103216, the customer needs markedly fewer process steps for the production of the printing means.

The term “vulcanizate” in the present sense is used for products or product components produced via vulcanization of a vulcanizable polymer mixture, in this case of the printing layer. The polymer mixture includes a rubber component or a plurality of rubber components. A vulcanizate features resilient properties. The crosslinking proceeds via sulfur (for example, in the case of NR) or of peroxides (for example, in the case of EPDM), in accordance with the type of rubber used. Thermal vulcanization at temperatures of from 130 to 200° C. is of particular importance. It is also possible to use low-temperature vulcanization or vulcanization by radiation. Information concerning vulcanizates that can be used can be found in United States patent application publication 2012/0103216, the disclosure of which is also a constituent of the present invention. In respect of the ingredients of the mixture, reference is in particular made to U.S. Pat. No. 6,774,162, the disclosure of which is likewise a constituent of the present invention.

In the process of United States patent application publication 2012/0103216, the entire surface of the printing layer prior to ablation takes the form of print element or of image-forming area, that is, the entire surface of a vulcanized printing layer that has not been subjected to any mechanical operations would transfer ink to the print substrate during the printing process, since the print original is produced only by the ablation that has not yet occurred. This is disadvantageous, since those regions of the printing layer that are not a constituent of the print original have to be ablated completely and most importantly over a large area. If these are relatively large coherent regions, they must nevertheless be ablated by very accurate mechanical operations using a laser or milling equipment provided for the production of the accurate print original, that is, large areas have to be ablated in a time-consuming process using very accurate tooling. If, in particular, the proportion of the area of the printing layer which after ablation is intended to form the print elements or to form the image-forming areas is comparatively small in comparison with the area that is to be ablated for the lower areas or the non-image-forming areas of the printing layer, the amount of resource required, in particular the amount of time required, is still further increased, and the costs also increase with this, for example, by way of the corresponding machine utilization, in particular the machine utilization times, and the wear on machinery and on tooling.

Furthermore, during printing processes the print original is regularly washed or cleaned in order to keep the print original free from contamination and to avoid any possible formation of undesired print elements or undesired image-forming areas in the ablated region of the lower areas or of the non-image-forming areas, due to ink particles or to dirt particles. In the light of this, the use of print originals produced by the known processes through ablation by a laser or ablation by milling is disadvantageous, since the regions produced by ablation in the lower areas or in the non-image-forming areas of the printing layer provide a comparatively good substrate for adherent ink particles or adherent dirt particles.

### SUMMARY OF THE INVENTION

It is an object of the invention to provide a multilayer sheet of the type described at the introduction in which the abovementioned disadvantages are overcome, and in particular the print original can be produced more easily and more rapidly than in methods known hitherto, and in particular the lower areas or the non-image-forming areas of the print original can be produced more easily and more rapidly than in methods known hitherto.

The multilayered layer structure of the invention is for use as one of a printing blanket and a printing plate for relief printing including flexographic printing. The multilayered layer structure includes: a first layer including a vulcanizate based on at least one elastomer; and, at least one further layer adhesively connected to the first layer in such a manner that the first layer is peelable from the further layer.

The invention is based on the realization that production of the lower areas or of the non-image-forming areas of the printing layer for the purposes of production of the print original via mechanical operations involving ablation, for example, via laser ablation or via milling, consumes large amounts of resources, in particular large amounts of time. Furthermore, the mechanical operations involving ablation produce a comparatively rough substrate. In the invention, therefore, the regions of the first layer of the multilayer sheet, this being the layer that can be used as printing layer of a printing blanket or of a printing plate, can be peeled from the at least one further layer. The printing layer can also be termed elastomer layer, on the basis of its composition, and/or can also be termed outer layer on the basis of its geometric arrangement. It is preferable that the printing layer is produced with use of an elastomeric material which is produced and marketed with product name AA6FIZ by Gummiwerk Kraiburg GmbH & Co. KG.

In the invention, therefore, the only regions of the printing layer that are subjected to complicated mechanical operations involving ablation by machinery are those in which it is also intended to form elevated print elements or elevated image-forming areas, as print original. The other regions which conventionally likewise require complicated mechanical operations involving ablation by machinery, in order to create the lower areas or the non-image-forming areas of the printing layer, are peeled or stripped easily and rapidly from the at least one further layer in the invention.

This is also advantageous because the substrate that remains after the peeling or stripping on the at least one further layer is more uniform and smoother than after mechanical operations involving ablation. It is thus more difficult for ink particles or dirt particles to adhere on the substrate. It is thus possible to eliminate or at least reduce the level of contaminants in the regions, produced by ablation, of the lower areas or non-image-forming areas of the printing layer, and the amount of resource required for the cleaning or the washing of the print original can thus be reduced.

On the one hand, it is possible here to begin with the laser ablation or mechanical ablation in the region of the print original, and then to separate and peel (strip) the excess area of the printing layer therefrom. On the other hand, it is possible to begin by separating and peeling (stripping) that area of the printing layer that does not require mechanical operations from the remaining region of the printing layer, and then to produce the print original in the remaining region of the printing layer via laser ablation or mechanical ablation. The first-mentioned procedure is preferable here, since during the mechanical operations involving ablation on the print original that area of the printing layer that is subsequently to be peeled (to be stripped) loses mechanical stability, in particular in the peripheral regions of the print original.

The peelability or strippability of the first layer is achieved in the invention in that the adhesion between the first layer and the at least one further layer is such as on the one hand to permit secure adhesion of the first layer on the at least one further layer and on the other hand to permit peeling or stripping of the first layer from the at least one further layer on exposure to a tensile force in essence in direction A, that is, perpendicularly to the plane of the multilayer sheet.

The separation of the printing layer into a region in which the elevated print elements or elevated image-forming areas have been formed or can be formed and an area which can be removed by peeling can be achieved by cutting, for example, manually with a carpet knife or the like, or else by machinery with an appropriate cutting tool or other separation means, an example being cutting by water jet or by sandblasting, separation by grinding, milling, or the like. It is therefore also conceivable to make concomitant use of mechanical operations involving ablation in machinery, for example, via laser or milling equipment, in order to bring about this separation, in that the ablation of the first layer proceeds as far as a depth that results in the separation of the first layer into the two regions.

For the purposes of this invention, the term “peelable” or “strippable” means that a layer can be released from its substrate, for example at least one further layer, via tensile forces which act in essence in direction A, that is, perpendicularly to the plane of the multilayer sheet. This release via the tensile forces takes place with maximal completeness, that is, leaving no residues, or leaving minimal residues, on the substrate. However, a sufficient condition for the invention is that the first layer is released from the at least one further layer at least in such a way that the remaining residues of the first layer on the at least one further layer nevertheless are lower areas or non-imaging-forming areas of the printing layer and do not therefore act as elevated print elements or elevated image-forming areas, that is, do not transfer any ink to the print substrate.

In one aspect of the invention, the multilayer sheet includes an intermediate layer which has a smaller separation resistance T than the first layer.

An advantage here is that this ensures the peelability or strippability of the first layer from the at least one further layer. The intermediate layer is therefore, in respect of the separation resistance T, the weakest member in the structure of the multilayer sheet, and the intermediate layer will therefore be the first to yield on exposure to an adequately large tensile force in essence in direction A, thus allowing the first layer to be peeled or stripped from the at least one further layer.

The intermediate layer here has a separation resistance T which is from 50% to 5% of the separation resistance T of the first layer, preferably from 40% to 5% of the separation resistance T of the first layer, particularly preferably from 30% to 5% of the separation resistance T of the first layer, very particularly preferably from 20% to 5% of the separation resistance T of the first layer. In absolute values, the intermediate layer has a separation resistance T from 1.2 N/mm to 0.1 N/mm, preferably a separation resistance T from 1.0 N/mm to 0.1 N/mm, particularly preferably a separation resistance T from 0.8 N/mm to 0.1 N/mm, very particularly preferably a separation resistance T from 0.6 N/mm to 0.4 N/mm.

The term separation resistance T here is to be understood in the sense of the standard DIN 53 530, which concerns the testing of organic materials by using a separation test on adhesively bonded fabric plies. In the sense of the standard DIN 53 530, this term “separation resistance T” is the quotient calculated from the separation force F determined in the separation test of the standard and the specimen width b. The separation resistance T is accordingly measured and stated as force per unit of distance in N/mm.

However, in an alternative it is also possible to reduce the separation resistance T of the intermediate layer with respect to the first layer in another way, for example, via the characteristics of the material of the intermediate layer and/or the nature of the surface and/or coating thereon.

The term “intermediate layer” here means a layer or else coating provided between the first layer and the at least one further layer of the multilayer sheet. An essential factor in the invention here is that the intermediate layer is in contact with the peelable or strippable first layer and with the substrate from which the first layer is to be peeled or stripped, and that the reduced separation resistance T of the intermediate layer with respect to the first layer takes effect between the first layer and the substrate. In other words, on exposure to a tensile force in essence in direction A the intermediate layer yields to the tensile force and parts. To this extent, as long as this effect is ensured, the remainder of the structure or of the nature of the multilayer sheet is of no further significance for the present invention.

In another aspect of the invention, the further layer and/or the intermediate layer includes a vulcanizate based on at least one elastomer.

An advantage here is that by use of a vulcanizate both for the first layer and for the intermediate layer it is possible to use the same production processes, in particular of vulcanization, and thus to keep production costs low. The crosslinking of the elastomers of the first layer and of the intermediate layer also produces good adhesion of the first layer on the at least one further layer. Although this adhesion can be overcome by tensile forces in the invention, reliable and durable adhesion of that area of the multilayer sheet that is intended to serve as print original in a printing blanket or in a printing plate is necessary in order that the print original can be used reliably and over a prolonged period as printing blanket or printing plate, since the print original here is not permitted to separate from its substrate. In particular, when a printing blanket is used on cylinder printing presses there are considerable centrifugal forces acting on the print original, and the adhesion between the first layer and the intermediate layer has to provide dependable resistance to these over a prolonged period.

In another aspect of the invention, the first layer and the further layer and/or the intermediate layer respectively include a vulcanizate based on the same elastomer.

An advantage here is that the first layer and the intermediate layer thus exhibit swelling resistance to the same solvents. This is particularly advantageous in the production or use of printing blankets and printing plates, since swelling of the first layer or of the intermediate layer of the printing blanket or of the printing plate can reduce or completely prevent delimitation between the elevated print elements or elevated image-forming areas of the print original and the lower areas or non-image-forming areas of the print original: swelling of a layer specifically in the peripheral region where solvents can penetrate laterally into the layers can cause raising of a lower area or non-image-forming area in such a way that this region likewise comes into contact with ink during the printing process and undesirably transfers this ink to the print substrate, that is, the swelling causes formation of elevated print elements or elevated image-forming areas of the print original that are entirely unintended. The print original can thus become altered, and a printed replicate thereof can thus be produced which renders the print substrate, and therefore also the print original, unusable.

This type of swelling is known when adhesives are used to bond individual layers of a multilayer sheet to one another. Since known adhesives are not dimensionally stable and have a tendency toward swelling over the course of time, it is advantageous to use, instead of adhesives, a vulcanizate based on the same elastomer as intermediate layer in order to bond the individual layers of a multilayer sheet, in particular the first layer and the intermediate layer, to one another in a manner that is adhesive but peelable or strippable.

In one aspect of the invention, the vulcanizate both of the first layer and of the further layer and/or of the intermediate layer can be ablated by a laser, preferably a carbon dioxide laser, a fiber laser, or a diode laser.

The use of a laser is advantageous because these are already conventionally used for the production of print originals, and existing manufacturing equipment can therefore be used for mechanical operations on the multilayer sheet of the invention. In particular, among the lasers that are most frequently used and have the highest performance levels in industry are by way of example carbon dioxide lasers (also termed CO2 lasers). Because they are relatively efficient and inexpensive, they are mainly used for mechanical operations on materials. Equally, fiber lasers feature robust construction and high beam quality and efficiency, and fiber lasers are therefore suitable for many applications: high-power fiber lasers can by way of example be used for welding, cutting, or ablation. Preference is also given to the use of a diode laser, since by virtue of their very compact design diode lasers feature comparatively high electrical/optical efficacy, comparatively long maintenance intervals, the possibility of transport of the beam in optical-conductor cables, and also very long lifetime. The multilayer sheet of the invention is thus rendered more acceptable to customers. The laser ablation process here can proceed either via laser ablation in the narrow sense or else via laser desorption.

In another aspect of the invention, the intermediate layer includes particles which are at least to some extent enclosed by the material of the intermediate layer.

An advantage here is that the intrinsic volume of these particles that are to some extent or completely enclosed reduces the amount of the elastomer material present in the intermediate layer between the first layer and the at least one further layer, and thus lowers the separation resistance T of the intermediate layer. This reduction of the separation resistance T can by way of example be influenced via the shape, the volume, or the nature of the surface, of the particles. This can also be achieved via the thickness of the intermediate layer in direction A or via the proportion of the particles in the composition of the intermediate layer. Equally, it is possible to admix, with the material of the intermediate layer, in particular elastomer material thereof, substances which reduce the separation force resistance T of the intermediate layer, in particular of the elastomer of the intermediate layer, to an extent such that the desired separation force resistance T is achieved.

Materials that can be used for the particles here are by way of example glass, polymer, metal, minerals, graphite, or PTFE (polytetrafluoroethylene). It is preferable that the particles are formed from polymer, particularly from thermoplastic polymer, in particular from polystyrene, in particular from the type of expandable polystyrene known with trademark “Styropor™”

In one aspect of the invention, the particles of the intermediate layer are at least to some extent spherical.

An advantage with this embodiment of the particles is that materials adhering on a spherical surface can be peeled comparatively easily. It is thus possible to achieve defined and reproducible separation behavior of the intermediate layer, thus permitting the first layer to be peeled or stripped from the substrate in a defined and reproducible manner. It is preferable here that absolutely no, or a minimum number of, residues are left behind on the substrate, or at least that the extent of these is sufficiently small and low in direction A that the residues do not spoil the print original.

In another aspect of the invention, the further layer takes the form of reinforcing layer, preferably dimensionally stable reinforcing layer.

An advantage of this preferred embodiment is that the at least one further layer in the form of reinforcing layer increases the stability of the multilayer sheet and thus renders it stronger, robuster, and easier to handle. The reinforcing layer here can include one type, or a plurality of various types, of reinforcement, for example one or more textile structures such as knitted fabric or woven fabric in various embodiments. These can by way of example have been embedded in a polymeric material, preferably in a vulcanized polymeric material, that is, be surrounded thereby, or include such a material in respect of the printing layer, in order to form a substrate or a corresponding surface for the peelable printing layer. It is also possible to use, as reinforcing layer, a foil such as a polymer foil (for example, polyamide foil) or metal foil. In the case of a sheet with many layers and at least two reinforcing layers, it is also possible to realize a combination of a textile structure and of a foil or of a foil composite.

It is particularly preferable here that the reinforcing layer takes the form of dimensionally stable reinforcing layer in that it includes, for example, aluminum, steel sheet, or a PET foil or PE foil. In this particularly preferred embodiment it is particularly advantageous that a dimensionally stable reinforcing layer of this type can bring about particularly high stability of the multilayer sheet.

In one aspect of the invention, there is a compressible layer arranged between the first layer and the further layer, preferably between the intermediate layer and the further layer.

The first layer, as printing layer, therefore lies directly on a compressible layer. This is advantageous because the compressible layer—also termed compression layer—thus serves for the avoidance of any flexing due to volume reduction in the printing zone, and serves to compensate impression differences. A decisive factor for the compressible layer is that it does not expand during compression, that is, that during compression its volume actually decreases, so that no material is displaced to cause lateral spread. Use may be made here by way of example of plastics microspheres in a rubber mixture, or of a microporous cell structure with enclosed gas chambers (foams). The materials relevant here are in particular polyurethanes, crosslinked polyethylenes, polypropylenes, NBR, neoprenes, and EPM. The modulus of elasticity is mostly in the range from 1 MPa to 1000 MPa. With regard to further details concerning the compressible layer, reference is in particular made to U.S. Pat. No. 6,019,042 and EP 2 070 717 A1, the disclosure of which is a constituent of the present invention.

In another aspect of the invention, the first layer includes a textile sheet, preferably an open textile sheet, particularly preferably a nonwoven material.

This is advantageous because the textile sheet, preferably the open textile sheet, particularly preferably the nonwoven material, can be penetrated by the material of the first layer, and it is thus possible to combine the properties of the material of the first layer and of the textile sheet with one another. The textile sheet can thus absorb mechanical forces which by way of example act on the first layer during mechanical operations or during peeling (stripping): grinding can thus be used to bring the first layer to a desired thickness. The textile sheet here can be a knitted fabric or woven fabric. It is preferable that the textile sheet is an open textile sheet, particularly a nonwoven material.

By way of example, the mechanical forces acting during mechanical operations involving grinding can be absorbed by the vulcanized material of the first layer as far as a thickness of about 1 mm. In the case of a thinner first layer, however, this can no longer be ensured, and it is therefore advantageous to embed, into the material of the first layer, an open textile sheet which then at least to some extent absorbs the mechanical forces. Irrespective of the layer thickness it is moreover advantageous to introduce, into the material of the first layer, an open textile sheet, preferably a nonwoven material, since this can likewise at least to some extent absorb the tensile forces during the peeling (stripping) of the first layer.

In another aspect of the invention, at least one layer includes a magnetic or magnetizable material.

This is advantageous since the multilayer sheet can thus be held via magnetic force on an underlay, for example, a print cylinder or a printing-plate holder. Adhesives have hitherto conventionally been used here. However, these can swell, that is, undergo alteration of their shape in particular in terms of height, and thus raise regions of the printing blanket or of the printing plate. Lower areas or non-image-forming areas can thus become raised in such a way that they undesirably act as elevated print elements or elevated image-forming areas and thus alter the print original and render the print substrate unusable, since the printed image produced differs from that desired.

In another aspect of the invention, the intermediate layer has a smaller separation resistance T than the first layer and is compressible.

This has the advantage that the properties of peelability (strippability) and compressibility can be combined with one another in a single layer. It is thus possible to reduce the amount of resource used for the production of a multilayer sheet which includes these two properties in the form of separate layers to be produced in succession. Production costs can thus be reduced. The multilayer sheet can moreover be produced with lower thickness, since the separate compressible layer can be omitted.

The realization of this combination of properties is rendered possible via the design of the intermediate layer. To this end, this can by way of example be provided with a greater layer thickness on the at least one further layer than in the case of an embodiment in which the intermediate layer is in essence intended to serve only for the peelability or strippability of those regions of the printing layer that are intended to form the lower areas or the non-image-forming areas. By virtue of the greater layer thickness, the intermediate layer has the effect of compressibility in the regions in which it is not peeled or stripped, that is, in those regions of the print original that are intended to form the print elements or the image-forming areas of the print original. It is thus possible for one and the same layer to fulfill two functions in the two different regions of the printing layer.

The peelability or strippability here can be achieved through the measures which have already been described above for this purpose. The compressibility of the intermediate layer can by way of example equally be achieved through these measures, that is, through a combination of inclusions in an elastomer-containing material, or through the properties of the material of the intermediate layer itself. However, it is also possible to introduce, into the intermediate layer, materials or elements which in essence serve only for compressibility and do not affect, or at least only insubstantially affect, the peelability or strippability of the intermediate layer, in particular reducing same only to an extent that continues to ensure the peelability or strippability.

In another aspect of the invention, the vulcanizate of the first layer and/or of the intermediate layer is a vulcanized thermoplastic-free rubber mixture including at least one rubber component, and also mixture ingredients.

Particular rubber components to be used are ethylene-propylene rubber (EPM), ethylene-propylene-diene rubber (EPDM), nitrile rubber (NBR), (partially) hydrogenated nitrile rubber (HNBR), fluororubber (FKM), chloroprene rubber (CR), natural rubber (NR), styrene-butadiene rubber (SBR), isoprene rubber (IR), butyl rubber (IIR), bromobutyl rubber (BIIR), chlorobutyl rubber (CIIR), butadiene rubber (BR), chlorinated polyethylene (CM), chlorosulfonated polyethylene (CSM), polyepichlorohydrin (ECO), ethylene-vinyl acetate rubber (EVA), acrylate rubber (ACM), ethylene-acrylate rubber (AEM), silicone rubber (VMQ), fluorinated methylsilicone rubber (MFQ), perfluorinated propylene rubber (FFPM), perfluorocarbon rubber (FFKM), or polyurethane (PU), where the abovementioned types of rubber are used without blending or in a blend, in particular in conjunction with one of the abovementioned types of rubber.

It is preferable to use the rubber component EPM, EPDM, SBR, BR, CR, NR, or NBR.

The conventional mixture ingredients include at least one crosslinking agent or one crosslinking agent system (crosslinking agent and accelerator). Other mixture ingredients are mostly also a filler and/or a processing aid, and/or a plasticizer, and/or an antioxidant, and also optionally other additional substances (for example, color pigments). In this connection, reference is made to the general prior art of rubber mixing technology.

In another aspect of the invention, as an alternative to the vulcanized thermoplastic-free rubber mixture as vulcanizate of the first layer and/or of the intermediate layer, a thermoplastic vulcanizate is used, including at least one thermoplastic component, at least one rubber component, at least partially crosslinked, and also mixture ingredients.

Preferred thermoplastic components here are polyethylene (PE), polypropylene (PP), polystyrene, polyamide (PA), or polyester (PES). Particular rubber components to be used are EPM, EPDM, SBR, BR, CR, NR, or NBR, in particular in an embodiment without blending. With regard to the mixture ingredients, reference is made to the abovementioned mixing technology as known in particular from the teaching in U.S. Pat. No. 6,774,162, the disclosure of which is likewise a constituent of the present invention.

In a particularly preferred aspect of the invention, the multilayer sheet of the invention includes at least the following layers in the following sequence, listed starting from the printing side in the direction opposite to A:
1. a first layer, preferably printing layer of a printing blanket or of a printing plate,
2. intermediate layer which parts during the peeling or stripping of the first layer,
3. compressible layer or else compression layer, and
4. reinforcing layer, preferably dimensionally stable reinforcing layer.

It is possible here that there are also further layers provided between the individual abovementioned layers and/or that there are also further layers following the undermost layer, that is, the reinforcing layer: following the undermost layer there can be at least also one further compressible layer and one reinforcing layer in this sequence, or else further layer combinations of this type.

However, it is preferable that the first layer is directly in contact with the compressible layer through the intermediate layer in a manner that is peelable or strippable, and that the compressible layer lies directly on the reinforcing layer. This type of structure made of the at least four layers mentioned is advantageous because it creates a multilayer sheet of which the first layer is peelable or strippable and the remaining area of which has been mounted in a compressible manner on a reinforcement, preferably on a dimensionally stable reinforcement.

The present invention also provides a process for the production of a multilayer sheet for use as printing blanket or printing plate for relief printing, in particular flexographic printing, with at least the following steps:
vulcanization of a first layer, which includes at least one elastomer, in a first step,
mechanical operations on the first layer to produce a prescribed layer thickness, in a further step, and application of the first layer on at least one further layer, in a further step,
where the first layer is peelable (strippable) from the at least one further layer.

This process sequence is based on the discovery that the first layer of a multilayer sheet of the invention can be produced more simply, more rapidly, and more advantageously when the first layer is first separately vulcanized and also brought to the desired layer thickness, before it is then applied to at least one further layer, in particular a reinforcement, particularly preferably to a dimensionally stable reinforcement.

Dimensionally stable reinforcements such as steel sheets and aluminum sheets in the type of thickness that is suitable for the production of printing blankets or printing plates are moreover available only in certain widths. It is therefore advantageous to convert the first layer of a multilayer sheet separately to the desired thickness via mechanical operation such as grinding, and then to convert it to the dimensions of the dimensionally stable reinforcement, and only then to apply it to the dimensionally stable reinforcement. Layer thickness tolerances achievable here are narrower than in products available on the market.

In one aspect of the invention, the step of application of the first layer on at least one further layer in the process for the production of a multilayer sheet includes the following steps:
application of a vulcanizable intermediate layer on one side of the first layer and/or on one side of the further layer, combining the first layer with the further layer with intermediate layer(s) thereof, and
vulcanization of the multilayer sheet.

This manner of provision of the peelability or strippability of the first layer with respect to the at least one further layer is advantageous because it is thus possible to omit means of adhesion such as adhesives. It is particularly preferable here that the intermediate layer and the first layer respectively include a vulcanizate based on the same elastomer. In both cases, swelling of the intermediate layer can be prevented or at least reduced when comparison is made with adhesive.

There are a number of possibilities available here for providing the intermediate layer between the first layer and the at least one further layer which by way of example can be a reinforcing layer, preferably a dimensionally stable reinforcing layer, or can be a compressible layer: it is possible merely to provide the vulcanizable material of the intermediate layer on one side of the first layer, for example, via spreading or spraying. It is also possible merely to provide the vulcanizable material of the intermediate layer on one side of the at least one further layer. It is also possible to provide the vulcanizable material of the intermediate layer both on one side of the first layer and on one side of the at least one further layer. In all cases, the first layer and the at least one further layer are combined in a further step with the respective side provided with the vulcanizable material of the intermediate layer, and then vulcanized, so that the intermediate layer takes the form of vulcanized intermediate layer between the first layer and the at least one further layer. To this end, the first layer and the at least one further layer can be forced together prior to and/or during the vulcanization process.

### BRIEF DESCRIPTION OF THE DRAWINGS

The invention will now be described with reference to the drawings wherein:

FIG. 1 is a diagram of a multilayer sheet in a first embodiment of the present invention;

FIG. 2 is a diagram of a multilayer sheet in the first embodiment of the present invention after a first step of mechanical operations;

FIG. 3 is a diagram of a multilayer sheet in the first embodiment of the present invention after a second step of mechanical operations;

FIG. 4 is a diagram of a multilayer sheet in the first embodiment of the present invention after a third step of mechanical operations;

FIG. 5 is a diagram of a multilayer sheet in a second embodiment of the present invention;

FIG. 6 is a diagram of a multilayer sheet in a third embodiment of the present invention;

FIG. 7 is a diagram of a multilayer sheet in a fourth embodiment of the present invention after a first step of mechanical operations;

FIG. 8 is a diagram of a multilayer sheet in the fourth embodiment of the present invention after a third step of mechanical operations;

FIG. 9 is a diagram of a multilayer sheet in the first embodiment of the present invention after a first production step;

FIG. 10 is a diagram of a multilayer sheet in the first embodiment of the present invention after a second production step;

FIG. 11 is a diagram of a multilayer sheet in the first embodiment of the present invention after a third production step; and,

FIG. 12 is a diagram of a multilayer sheet in the first embodiment of the present invention after a fourth production step.

### DESCRIPTION OF THE PREFERRED EMBODIMENTS OF THE INVENTION

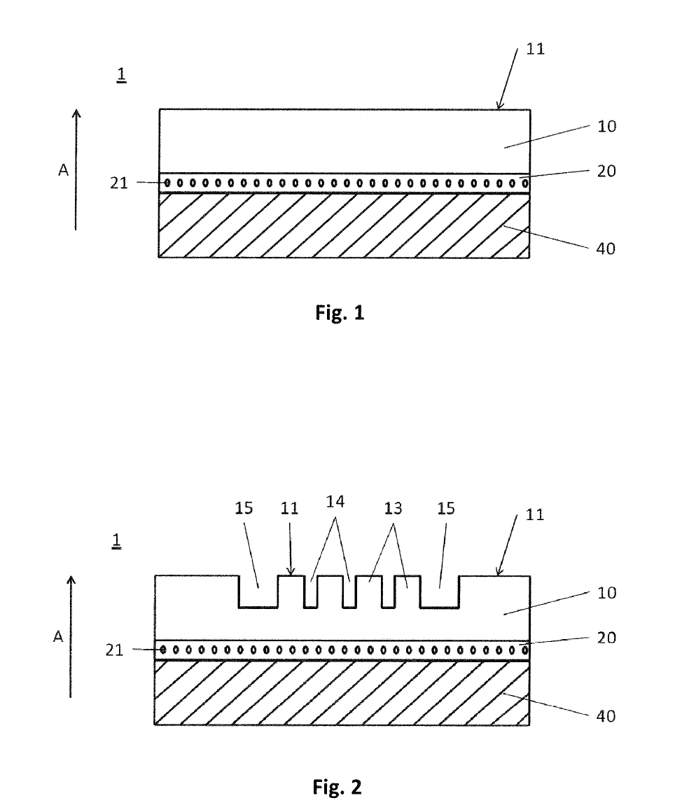

FIG. 1 is a diagram of a multilayer sheet 1 in a first embodiment of the present invention. The multilayer sheet 1 of the invention, which can preferably be used as printing blanket 1 or printing plate 1 in relief printing processes, in particular in flexographic printing processes, includes at least one first layer 10 and at least one further layer (30, 40).

The first layer 10 takes the form of outermost layer of the multilayer sheet 1 in the direction A perpendicular to the plane of the printing blanket 1 or of the printing plate 1, and therefore takes the form of also printing layer 10 of the printing blanket 1 or of the printing plate 1. The surface 11 of the printing layer 10 therefore faces toward the print substrate (not shown) during the printing process.

The one further layer (30, 40) preferably takes the form of reinforcing layer 40, particularly preferably that of dimensionally stable reinforcing layer 40, and can therefore include aluminum, steel sheet, PET foil, or PE foil, or can consist of one of these materials. The intention here is that the further layer (30, 40) be considered below to be dimensionally stable reinforcing layer 40, without restriction of the invention to this embodiment.

In the invention, the printing layer 10 and the dimensionally stable reinforcing layer 40 have been bonded to one another in such a way that the printing layer 10 can be peeled or stripped from the dimensionally stable reinforcing layer 40.

This can be achieved by way of example in that in the first embodiment the printing blanket 1 or the printing plate 1 includes, between the printing layer 10 and the dimensionally stable reinforcement 40, an intermediate layer 20 which bonds these to one another in a manner that is adhesive but peelable (strippable). The adhesive but peelable (strippable) bond between the printing layer 10 and the dimensionally stable reinforcement 40 is achieved in the first embodiment of the present invention in that the intermediate layer 20 includes a material which at least to some extent encloses particles 21, which are preferably spherical. The enclosed particles 21 reduce the separation resistance T of the intermediate layer 20 in comparison with the separation resistance T of the printing layer 10 in such a way that when a tensile force acts in direction A it is only the intermediate layer 20, and not the printing layer 10, that parts.

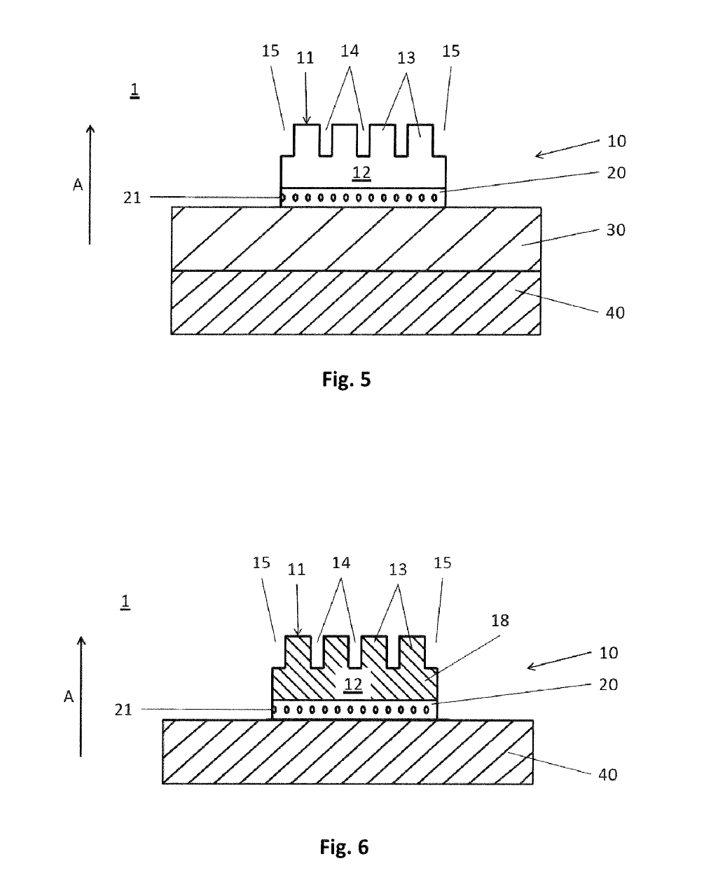

In this first embodiment, the intermediate layer 20 bonds the printing layer 10 directly to the dimensionally stable reinforcement 40, but there are also possible embodiments in which the intermediate layer 20 bonds the printing layer 10 to another layer, for example, to a compressible layer 30 (cf. FIG. 5) in a manner that is adhesive but peelable (strippable).

FIG. 1 at the same time shows a multilayer sheet 1 of the invention in the form of printing blanket 1 or printing plate 1 for a relief printing process, in particular a flexographic printing process, prior to a first step of mechanical operations for the production of a print original 12, which is intended to take the form of elevated print elements 13 or of elevated image-forming areas 13 (cf. FIGS. 2 to 6). In this condition, the printing blanket 1 or the printing plate 1 has a flat surface 11 of the printing layer 10 with a prescribed thickness, and is retained by way of the dimensionally stable reinforcing layer 40, in such a way that the surface 11 of the printing layer 10 can be subjected to mechanical operations.

FIG. 2 is a diagram of a multilayer sheet 1 in the first embodiment of the present invention after a first step of mechanical operations. In this first step of mechanical operations for the production of a print original 12, the lower areas 14 or the non-image-forming areas 14 of the print original 12 are formed via ablation which can be achieved by way of example by a laser or by milling equipment or the like; the elevated print elements 13 or the image-forming areas 13 of the print original 12 are then higher than these.

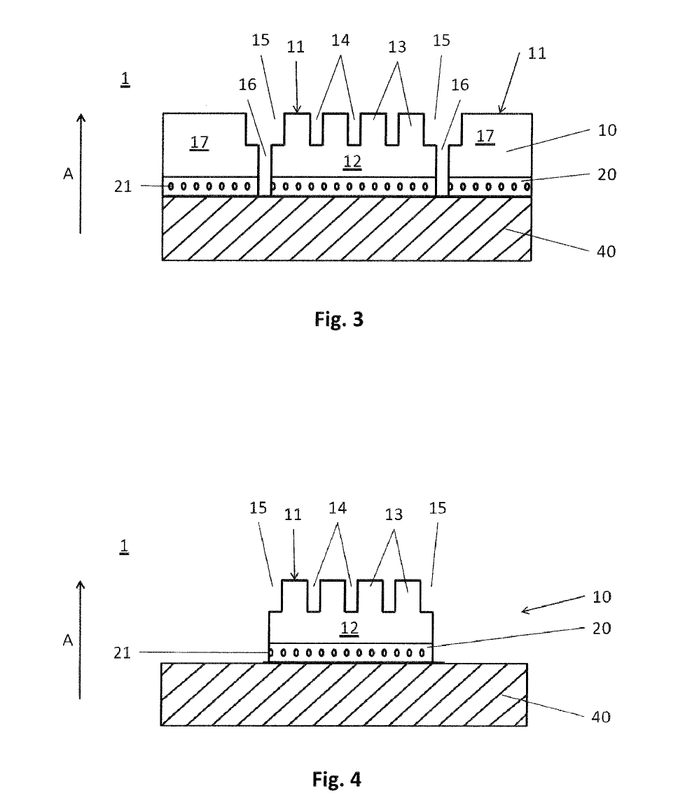

After these mechanical operations involving ablation, the print original 12 is surrounded in the plane of the printing blanket 1 or of the printing plate 1 at the outer periphery thereof by a peripheral and coherent outermost lower area 15 or outermost non-image-forming area 15, which does not serve to form the print original 12 itself but instead serves for the delimitation of the print original 12 with respect to the surrounding region 17 (cf. FIG. 3) of the printing layer 10.

FIG. 3 is a diagram of a multilayer sheet 1 in the first embodiment of the present invention after a second step of mechanical operations. In this second step of mechanical operations for the production of a print original 12, the intermediate layer 20 is divided in the outermost lower area 15 or outermost non-image-forming area 15 by a separating lower area 16 or a cut lower area 16, in such a way that the printing layer 10 is divided into a region which forms the print original 12 and a further region which is that region 17 of the printing layer 10 that is to be peeled or to be stripped.

FIG. 4 is a diagram of a multilayer sheet 1 in the first embodiment of the present invention after a third step of mechanical operations. In this third step of mechanical operations for the production of a print original 12, that region 17 of the printing layer 10 that is to be peeled or to be stripped is peeled from the dimensionally stable reinforcement 40. To this end, the intermediate layer 20 has a separation resistance T smaller than that of the printing layer 10 and also that of the dimensionally stable reinforcement 40, and that region 17 of the printing layer 10 that is to be peeled or to be stripped can therefore be removed from the dimensionally stable reinforcement 40 by tensile force in essence in direction A, leaving minimal or no residue.

After the steps of mechanical operations described in connection with FIGS. 1 to 4, all that therefore remains on the dimensionally stable reinforcement 40 is that region of the printing layer 10 in which the print original 12 has been formed. The remaining region 17 could be peeled (stripped) from the dimensionally stable reinforcement 40 in a simple and rapid manner in the invention, whereas the method known hitherto also required that this region be subjected to time-consuming ablation via mechanical operations involving a laser or other mechanical operations, in exactly the same way as that required for the desired lower areas (14, 15) or the desired non-image-forming areas (14, 15) of the print original 12. A significant simplification of the production of a print original 12 for relief printing, in particular flexographic printing, is thus achieved in the invention, with the corresponding advantages of the attendant saving of time and of cost.

In an alternative, the sequence of the steps of mechanical operations described in connection with FIGS. 1 to 4 can also proceed in reverse in the invention. In this case, the region 17 is first separated by a separating lower area 16 or a cut lower area 16 from that region of the print original 12 that is subsequently to be subjected to mechanical operations, with the elevated print elements 13 or elevated image-forming areas 13, and is peeled or stripped. Only then are mechanical operations involving ablation used to form the elevated print elements 13 or elevated image-forming areas 13 of the print original 12 and lower areas (14, 15) thereof or non-image-forming areas (14, 15) thereof.

FIG. 5 is a diagram of a multilayer sheet 1 in a second embodiment of the present invention. In this second embodiment, the intermediate layer 20 bonds the printing layer 10 in a manner that is adhesive but peelable or strippable to a compressible layer 30, which itself in turn is adhesively bonded to the dimensionally stable reinforcing layer 40. It is thus possible to introduce concomitantly the advantages of a compressible layer 30 into the multilayer sheet 1 of the invention.

FIG. 6 is a diagram of a multilayer sheet 1 in a third embodiment of the present invention. In this third embodiment, an open textile sheet 18, preferably a nonwoven material 18, has been provided to the printing layer 10 in order to strengthen the material of the printing layer 10 to resist mechanical forces. These can arise by way of example during the peeling (stripping) of that region 17 of the printing layer 10 that is to be peeled or to be stripped, during the mechanical operations involving ablation on the lower areas 14 or non-image-forming areas 14 of the print original 12, or on the outermost lower area 15 or outermost non-image-forming area 15 of the print original 12, or else on the separating lower area 16 or cut lower area 16 of the outermost lower area 15, for example, by milling, or else during mechanical operations on the printing layer 10 via, for example, grinding, in order to bring the printing layer 10 to the desired layer thickness.

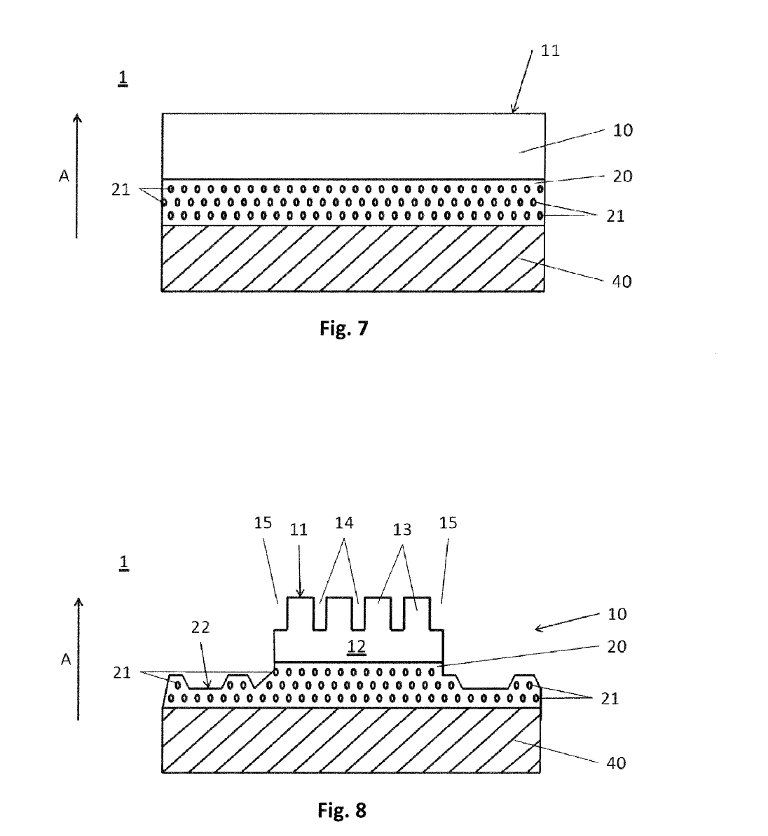

FIG. 7 is a diagram of a multilayer sheet 1 in a fourth embodiment of the present invention after a first step of mechanical operations. The multilayer sheet 1 of the invention in the fourth embodiment can preferably be used as printing blanket 1 or printing plate 1 in relief printing processes, in particular in flexographic printing processes, and includes at least one first layer 10, one compressible intermediate layer 20, and at least one further layer (30, 40) (cf. FIG. 1). This first step of mechanical operations here corresponds to the first step of mechanical operations in the first embodiment, that is, FIG. 7 shows the printing blanket 1 or the printing plate 1 prior to a first step of mechanical operations for the production of a print original 12 intended to take the form of elevated print elements 13 or elevated image-forming areas 13 (cf. FIGS. 2 to 6).

In the multilayer sheet 1 in the fourth embodiment, the peelability or strippability is also brought about via the intermediate layer 20 via the particles 21 enclosed in the material of the intermediate layer 20. In order to achieve a compressible effect here, the intermediate layer 20 has markedly greater dimensions in direction A, that is, has a greater layer thickness, than in the first to third embodiment. By virtue of this greater layer thickness it is possible to achieve, via the intermediate layer 20, a compressible effect in the region of the printing layer 10 in which the print original 12 takes the form of elevated print elements 13 or elevated image-forming areas 13, without any need to provide a separate compressible layer 30, as described in relation to the second embodiment in FIG. 5.

The greater layer thickness of the intermediate layer 20 in FIG. 7 here is indicated diagrammatically in that the arrangement has the enclosed particles 21 in three horizontal rows. However, the enclosed particles 21 in the material of the intermediate layer 20 in the actual embodiment will have relatively random distribution and arrangement.

FIG. 8 is a diagram of a multilayer sheet 1 in the fourth embodiment of the present invention after a third step of mechanical operations. This third step of mechanical operations here corresponds to the third step of mechanical operations in the first embodiment in FIG. 4, that is, FIG. 8 shows a multilayer sheet 1 in which that region 17 of the printing layer 10 that is to be peeled or to be stripped has been peeled from the dimensionally stable reinforcement 40. That region of the intermediate layer 20 that is located below the print original 12 in direction A acts in this case as compressible layer 30 (cf. FIG. 5).

In this diagram of FIG. 8, it can be seen that by virtue of the comparatively large layer thickness of the intermediate layer 20 aimed at achieving a compressible effect in the region of the print original 12, in the surrounding region 17 (cf. FIG. 3) of the printing layer 10 there can be residues of the intermediate layer 20 in the form of residues of material 22 which project in direction A and in which there can also be particles 21 enclosed. This type of surface of the peeled or stripped intermediate layer 20 in the surrounding region 17 can also occur in the first to third embodiment, but in order to improve clarity it is not present in the diagrams of the corresponding FIGS. 4 to 6. These projecting residues of material 22 in direction A in all embodiments are sufficiently small that they have no effect on the print original 12, that is, they do not act as elevated print elements 13 or elevated image-forming area 13.

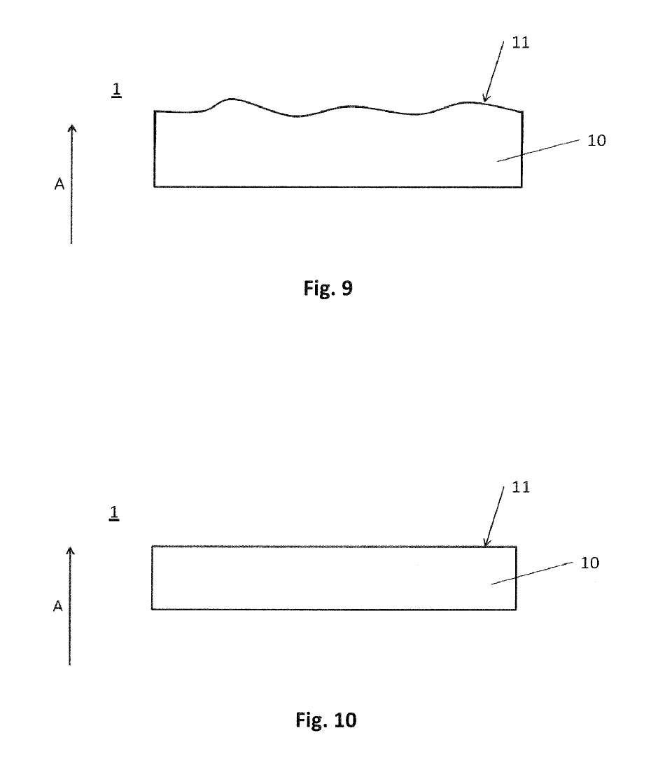

FIG. 9 is a diagram of a multilayer sheet 1 in the first embodiment of the present invention after a first production step. In this first production step, the material of the first layer 10 which can form the printing layer 10 of a printing blanket 1 or of a printing plate 1 is applied on a surface (not shown) and vulcanized. The vulcanized printing layer 10 can then, or after a step of mechanical operations that follows, be peeled from the surface. The printing layer 10 here can include at least slight unevenness on its upper side 11, which in the depiction of FIG. 9 is oriented in direction A.

FIG. 10 is a diagram of a multilayer sheet 1 in the first embodiment of the present invention after a second production step. In this second production step, the uneven surface 11 of the printing layer 10 has been subjected to mechanical operations in order to obtain maximum evenness of surface 11 of the printing layer 10 with a desired layer thickness. The meaning of an even surface 11 here is that the printing layer 10 has a surface 11 which includes elevations, peaks, corrugation, and the like only to a small extent such that they do not disrupt or impair the formation of, or the differentiation of, elevated print elements 13 or elevated image-forming areas 13 of the print original 12 and lower areas 14 or non-image-forming areas 14 of the print original 12. The mechanical operations can use by way of example mechanical operations such as grinding, brushing, polishing, or finishing.

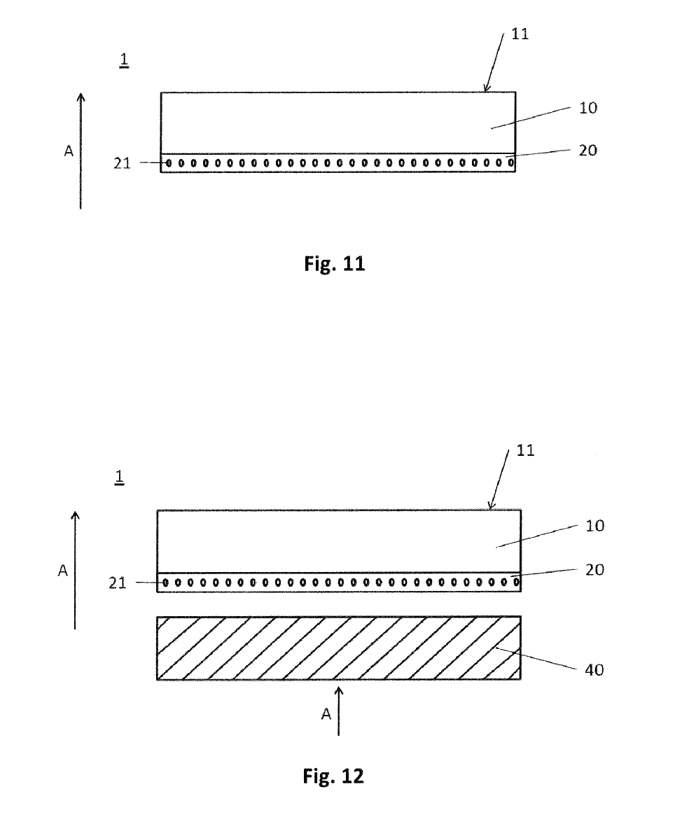

FIG. 11 is a diagram of a multilayer sheet 1 in the first embodiment of the present invention after a third production step. In this third production step, an intermediate layer 20 has been applied to that side of the printing layer 10 that is opposite to the upper side 11 of the printing layer 10 in direction A and which therefore forms the underside of the printing layer 10. In this embodiment, this intermediate layer 20 includes a material which at least to some extent encloses particles 21, which are preferably spherical. The enclosed particles 21 reduce the separation resistance T of the intermediate layer 20 in comparison with the separation resistance T of the printing layer 10 in such a way that when a tensile force acts in direction A it is only the intermediate layer 20, and not the printing layer 10, that parts.

While FIG. 11 depicts only application of the material of the intermediate layer 20 to the underside of the printing layer 10, it is equally possible instead in the invention to apply the material of the intermediate layer 20 to the direction-A-oriented side of the further layer (30, 40) intended to be bonded to the printing layer 10 via the intermediate layer 20 in the multilayer sheet 1. Equally, it is also possible to apply the material of the intermediate layer 20 both to the underside of the printing layer 10 and to the direction-A-oriented side of the further layer (30, 40). In this case, applications on the respective surfaces of the layers (10, 30, 40) can be identical or of different thicknesses.

FIG. 12 is a diagram of a multilayer sheet 1 in the first embodiment of the present invention prior to a fourth production step. In this fourth production step that follows, the two layers (10, 40) which are to be bonded to one another via the intermediate layer 20 in a manner that is adhesive but peelable or strippable are now forced together in direction A by an applied pressure force F, and vulcanized while thus fixed. The complete crosslinking of the material of the intermediate layer 20 takes place in this vulcanization step. The multilayer sheet 1 of the printing blanket 1 or of the printing plate 1 in FIG. 1 is formed as a result of this fifth production step: vulcanization.

As an alternative, for production steps 1 to 5 of FIGS. 9 to 12 it is also possible to use, instead of the multilayer sheet 1 of the first embodiment, that of the second and third embodiment.

It is therefore possible, for the production of a multilayer sheet 1 of the second embodiment, in the fourth production step, to use, instead of the dimensionally stable reinforcing layer 40, a compressible layer 30 which itself can then optionally be bonded in further production steps for example via adhesion or equally vulcanization to, for example, a dimensionally stable reinforcing layer 40. The vulcanization in FIG. 9 thus produces the type of multilayer sheet 1 depicted in FIG. 5 after mechanical operations involving ablation.

For the production of a multilayer sheet 1 of the third embodiment in the first production step, moreover, the open textile sheet 18, preferably the nonwoven material 18, is to be embedded into the material to be vulcanized in the printing layer 10, in order to obtain, after vulcanization in FIG. 9, a multilayer sheet 1 of the type depicted in FIG. 6 after mechanical operations involving ablation.

It is understood that the foregoing description is that of the preferred embodiments of the invention and that various changes and modifications may be made thereto without departing from the spirit and scope of the invention as defined in the appended claims.

### KEY

### (Part of the Description)

A Direction perpendicular to the plane of the multilayer sheet 1
F Applied pressure force in direction A
1 Multilayer sheet, preferably printing blanket or printing plate
10 Printing layer
11 Surface of the printing layer 10, facing toward the print substrate during the printing process

12 Print original or print relief of the printing layer 10
13 Elevated print elements or elevated image-forming areas of the print original 12
14 Lower areas or non-image-forming areas of the print original 12
15 Outermost lower area or outermost non-image-forming area of the print original 12
16 Separating lower area or cut lower area of the outermost lower area 15
17 Region that is to be peeled or to be stripped in the printing layer 10
18 Open textile sheet, preferably nonwoven material
20 Intermediate layer
21 Particles, in particular hollow spheres or Styropor spheres
22 Projecting residues of material of the intermediate layer 20
30 Compressible layer, compression layer
40 Further layer, in particular reinforcing layer, preferably dimensionally stable reinforcing layer

What is claimed is:

1. A multilayered layer structure for use as one of a printing blanket and a printing plate for relief printing including flexographic printing comprising:
a first layer including a vulcanizate based on at least one elastomer; and,
at least one further layer adhesively connected to said first layer in such a manner that said first layer is peelable from said further layer.

2. The multilayered layer structure of claim 1, wherein said first layer has a first separation resistance (T₁), the multilayered layer structure further comprising an intermediate layer disposed between said first layer and said further layer and having a second separation resistance (T₂) which is less than said first separation resistance (T₁).

3. The multilayered layer structure of claim 1, wherein said further layer includes a vulcanizate based on at least one elastomer.

4. The multilayered layer structure of claim 2, wherein at least one of said further layer and said intermediate layer includes a vulcanizate based on at least one elastomer.

5. The multilayered layer structure of claim 1, wherein said first layer and said further layer each includes a vulcanizate based on the same elastomer.

6. The multilayered layer structure of claim 2, wherein said first layer, said further layer and said intermediate layer each includes a vulcanizate based on the same elastomer.

7. The multilayered layer structure of claim 3, wherein said vulcanizate of said first layer and said vulcanizate of said further layer are configured to be ablatable via a laser.

8. The multilayered layer structure of claim 7, wherein said laser is one of a carbon dioxide laser, a fiber laser, and a diode laser.

9. The multilayered layer structure of claim 1, wherein said further layer and said intermediate layer each include a vulcanizate based on at least one elastomer, said multilayer structure further comprising:
an intermediate layer including a vulcanizate based on at least one elastomer;
said vulcanizate of each of said first layer, said intermediate layer and said further layer is ablatable via a laser.

10. The multilayered layer structure of claim 2, wherein said intermediate layer is made of a first material and includes particles which are at least partially enclosed by said first material.

11. The multilayered layer structure of claim 10, wherein said particles are configured to be at least partially spherical.

12. The multilayered layer structure of claim 1, wherein said further layer is configured as a reinforcing layer.

13. The multilayered layer structure of claim 1, wherein said further layer is configured as a dimensionally stable reinforcing layer.

14. The multilayered layer structure of claim 1, further comprising a compressible layer disposed between said first layer and said further layer.

15. The multilayered layer structure of claim 2, further comprising a compressible layer disposed between said further layer and said intermediate layer.

16. The multilayered layer structure of claim 1, wherein said first layer includes a textile layer structure.

17. The multilayered layer structure of claim 1, wherein said first layer includes one of a open textile layer structure and a non-woven material.

18. The multilayered layer structure of claim 1, wherein at least one of said first layer and said further layer includes at least one of a magnetic material and a magnetizable material.

19. The multilayered layer structure of claim 2, wherein said intermediate layer is configured as a compressible layer.

20. A method for making a multilayered layer structure for use as one of a printing blanket and a printing plate for relief printing including flexographic printing, the method comprising the steps of:
vulcanizing a first layer which includes at least one elastomer;
mechanically working the first layer to generate a predetermined layer thickness;
applying the first layer onto at least one further layer wherein the adhesion between the first layer and the further layer is configured so as to permit the first layer to be peeled off or stripped from the at least one further layer.

21. The method of claim 20, wherein said method step of applying the first layer onto the at least one further layer includes the steps of:
applying a vulcanizable intermediate layer to at least one of a first side of the first layer and a first side of the further layer;
joining the first layer with said further layer along with the intermediate layer; and,
vulcanizing the multilayered layer structure.

22. The method of claim 21, wherein the first layer has a first separation resistance (T₁) and the intermediate layer has a second separation resistance (T₂); said second separation resistance (T₂) being less than said first separation resistance (T₁).
